(19) United States
(12) Patent Application Publication
(10) Pub. No.: US 2026/0312094 A1
(43) Pub. Date: Oct. 8, 2026

(54) FUEL CELL SYSTEM

(71) Applicant: AISAN KOGYO KABUSHIKI KAISHA, Obu-shi, Aichi (JP)

(72) Inventor: Daisaku ASANUMA, Gamagori-shi (JP)

(73) Assignee: AISAN KOGYO KABUSHIKI KAISHA, Obu-shi, Aichi (JP)

(21) Appl. No.: 19/484,611

(22) PCT Filed: Mar. 7, 2024
(86) PCT No.: PCT/JP2024/008649

§ 371 Date: Nov. 14, 2025

(30) Foreign Application Priority Data
Jun. 6, 2023 (JP) 2023-093193

(51) Int. Cl. H01M 8/04537; B60L 50/75; B60L 58/12; B60L 58/40; H01M 8/04858; H01M 10/42; H01M 10/48; H01M 16/00

(52) U.S. Cl. CPC H01M 8/04626; B60L 50/75; B60L 58/12; B60L 58/40; H01M 8/04858; H01M 10/425; H01M 10/48; H01M 16/006; H01M 2220/20; H01M 2250/20; H01M 2250/402

(57) ABSTRACT

This fuel cell system comprises a fuel cell (FC) (1), a motor (2), a first power line (3) that connects the FC (1) and the motor (2), a battery (4), and a second power line (5) that connects the battery (4) and the first power line (3). The first power line (3) is provided with an FC relay (7) that opens and closes the first power line (3), and the second power line (5) is provided with a battery relay (8) that opens and closes the second power line (5). In order to place an upper limit on the output of the FC (1) and the battery (4), a control means (ECU) (10) that controls the opening/closing of both relays (7, 8) is provided. When the charge rate of the battery (4) being monitored is less than 30%, the ECU (10) implements control to close both relays (7, 8).

### CROSS-REFERENCE TO RELATED APPLICATIONS

This is a US national phase application based on the PCT International Patent Application No. PCT/JP2024/008649 filed on Mar. 7, 2024, and claiming the priority to Japanese Patent Application No. 2023-093193 filed on Jun. 6, 2023, the entire contents of which are incorporated by reference herein.

### TECHNICAL FIELD

The technique disclosed in this description relates to a fuel cell system, which will be used as a power source for electric vehicles and includes a fuel cell connected to a load device, and a battery placed in an electrical discharge path extending from the fuel cell to the load device and connected in parallel to the fuel cell.

### BACKGROUND ART

As the above type of technique, for example, a fuel cell system described in the following Patent Document 1 is conventionally known. This system includes a fuel cell, a load device, a first power wire connecting the fuel cell and the load device, a battery, and a second power wire connecting the battery and the first power wire. On the first power wire, a voltage converter is provided to convert voltage between an inter-terminal voltage of the fuel cell and a voltage on a load device side.

### RELATED ART DOCUMENTS

### Patent Documents

Patent Document 1: Japanese unexamined patent application publication No. 2011-228294

### SUMMARY OF INVENTION

### Problems to be Solved by the Invention

In the fuel cell system described in Patent Document 1, the voltage converter can control the supply of electric power to the load device so as not to exceed upper-limit power of the fuel cell. However, this voltage converter itself may lead to increased cost and size. In recent years, fuel cell systems to be mounted in electric vehicles, etc. have been demanded to be configured as simple and low-cost systems.

The disclosure has been made to address the above problems and has a purpose to provide a fuel cell system, which is simple and low-cost, and can control electric power to be supplied to a load device so as not to exceed upper-limit power of a fuel cell and a battery without using a voltage converter.

### Means of Solving the Problems

(1) To achieve the above purpose, one aspect of the disclosure provides a fuel cell system including: a fuel cell; a load device; a first power line connecting the fuel cell and the load device; a battery; and a second power line connecting the battery and the first power line, wherein the fuel cell system further includes: a first relay provided on the first power line to open and close the first power line; and a second relay provided on the second power line to open and close the second power line.

According to the above-described configuration (1), the first relay is opened/closed to turn off/on power supply from the fuel cell to the load device, and the second relay is opened/closed to turn off/on power supply from the battery to the load device. Therefore, appropriate control of the first relay and the second relay to open and close can supply the electric power to the load device according to the output conditions of the fuel cell and the battery.
(2) To achieve the above purpose, preferably, the above-described configuration (1) includes: relay control means for controlling the first relay and the second relay to open and close to restrict an upper limit of output of the fuel cell and an upper limit of output of the battery; and charge-state monitoring means for monitoring a state of charge of the battery, wherein the relay control means controls the first relay and the second relay to close when the state of charge of the battery being monitored by the charge-state monitoring means is smaller than a third predetermined value.

According to the above-described configuration (2), in addition to the operations of the configuration (1), when the state of charge of the battery under monitoring is smaller than the third predetermined value, the relay control means controls the first relay and the second relay to close, allowing the fuel cell and the battery to output power in an uncontrolled manner. Thus, the output of the fuel cell and the output of the battery are adjusted to approach an allowable usage range.
(3) To achieve the above purpose, in the above-described configuration (2), preferably, the relay control means is configured to: (i) control the first relay and the second relay to open when the monitored state of charge is a first predetermined value or larger; (ii) control the first relay to open and the second relay to close when the monitored state of charge is a second predetermined value or larger and less than the first predetermined value; (iii) control the first relay and the second relay to close when the monitored state of charge is the third predetermined value or larger and less than the second predetermined value and the load device is under braking; and (iv) control the first relay to open and the second relay to close when the monitored state of charge is the third predetermined value or larger and less than the second predetermined value and the load device is under regeneration, and have a relationship: the first predetermined value >the second predetermined value >the third predetermined value.

According to the above-described configuration (3), in addition to the operations of the configuration (2), (i) when the monitored state of charge is the first predetermined value or larger, the relay control means controls the first relay and the second relay to open, so that the output of the fuel cell and the output of the battery are zero. (ii) When the monitored state of charge is the second predetermined value or larger and less than the first predetermined value, the relay control means controls the first relay to open and the second relay to close, so that the output of the fuel cell is zero and the output of the battery is uncontrolled. (iii) When the monitored state of charge is the third predetermined value or larger and less than the second predetermined value and the load device is under braking, the relay control means controls the first relay and the second relay to close, so that the output of the fuel cell and the output of the battery are each uncontrolled. (iv) When the monitored state of charge is the third predetermined or larger and less than the second predetermined value and the load device is under regeneration, the relay control means controls the first relay to open and the second relay to close, so that the output of the fuel cell is zero and the output of the battery is uncontrolled. Thus, the output of the fuel cell and the output of the battery are adjusted to approach the allowable usage range by the foregoing controls (i) to (iv).
(4) To achieve the above purpose, in the above-described configuration (2) or (3), preferably, when the monitored state of charge is smaller than the third predetermined value, the relay control means corrects a command output value for the load device according to the state of charge to suppress the command output value.

According to the above-described configuration (4), in addition to the operations of the configuration (2) or (3), when the monitored state of charge is smaller than the third predetermined value, the relay control means corrects the command output value for the load device according to the state of charge to suppress the command output value. Thus, when the state of charge is smaller than the third predetermined value, power supply from the fuel cell and the battery to the load device is precisely suppressed according to the state of charge.
(5) To achieve the above purpose, preferably, the above-described configuration (1) includes load output determining means for determining a command output value for the load device, wherein the load output determining means determines the command output value by subtracting a reduced output value of the fuel cell and a reduced output value of the battery from a required output value of the load device.

According to the above-described configuration (5), in addition to the operations of the configuration (1), the command output value for the load device is determined to match the output capacity status of the fuel cell and the output capacity status of the battery at that time.

### Effects of the Invention

The above-described configuration (1) can provide a simple and low-cost fuel cell system capable of controlling electric power to be supplied to the load device so that the electric power does not exceed the upper-limit power of the fuel cell and the battery, without using a voltage converter.

In addition to the effects of the configuration (1), the above-described configuration (2) can restrict the upper limits of the output of the fuel cell and the output of the battery when the state of charge of the battery decreases.

In addition to the effects of the configuration (2), the above-described configuration (3) can restrict the upper limits of the output of the fuel cell and the output of the battery with more accuracy according to changes in the state of charge of the battery.

In addition to the effects of the configuration (2), the above-described configuration (4) can restrict the upper limits of the output of the fuel cell and the output of the battery with more accuracy when the state of charge of the battery further decreases.

In addition to the effects of the configuration (1), the above-described configuration (5) can suppress excessive output loads on the fuel cell and the battery.

### BRIEF DESCRIPTION OF THE DRAWINGS

FIG. 1 is a block diagram showing a fuel cell system mounted in an electric cart in an embodiment.

FIG. 2 is a flowchart showing one example of contents of “electric power supply control” in the embodiment.

FIG. 3 is an output correction value map to be referred to when an output correction value is determined according to a state of charge of a battery in the embodiment.

### MODE FOR CARRYING OUT THE INVENTION

A detailed description of an embodiment of a fuel cell system, applied to compact electric vehicles (electric carts), will now be given referring to the accompanying drawings.

### Overview of Fuel Cell System

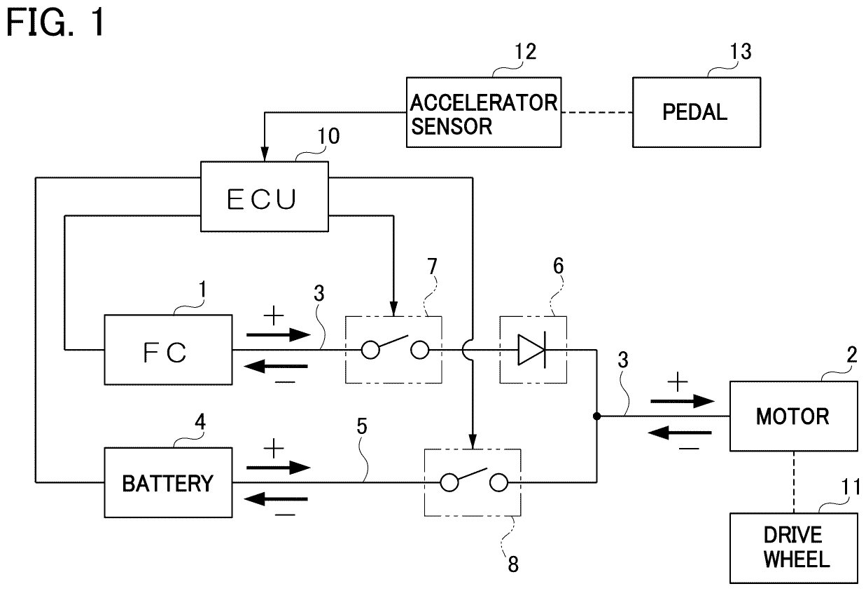

FIG. 1 is a block diagram showing a fuel cell system mounted in an electric cart in the present embodiment. This fuel cell system includes a fuel cell (FC) 1, an electrically-operated motor 2, a first power line 3 connecting the FC 1 and the motor 2, a battery 4, and a second power line 5 connecting the battery 4 and the first power line 3.

The FC 1 is an electrochemical cell that converts the chemical energy of fuel and oxidant into electricity through an oxidation-reduction reaction, and has a well-known configuration. The motor 2 has a well-known configuration and corresponds to one example of a “load device” of the present disclosure. The battery 4 in the present embodiment consists of a secondary battery that can be charged and discharged.

In the present embodiment, on the first power line 3, a diode 6 for rectification and an FC relay 7 for opening and closing the first power line 3 are provided in series. The FC relay 7 corresponds to a “first relay” of the disclosure. The second power line 5 is connected to the first power line 3 between the diode 6 and the motor 2. On the second power line 5, a battery relay 8 is provided to open and close the second power line 5. The battery relay 8 corresponds to a “second relay” of the disclosure. The FC relay 7 and the battery relay 8 have a well-known configuration capable of opening and closing when electrically operated. The fuel cell system further includes an electronic control unit (ECU) 10 to control opening/closing of each relay 7, 8. The ECU 10 has a well-known configuration including a central processing unit (CPU) for performing arithmetic processing, a memory, input/output ports, etc. The ECU 10 corresponds to one example of “relay control means” of the disclosure.

In the present embodiment, the motor 2 is drive-coupled to a drive wheel 11 of the electric cart. An accelerator sensor 12 is connected to the ECU 10. The accelerator sensor 12 is configured to detect an operation angle of a pedal 13 operated by a user of the electric cart as an accelerator opening degree, and output a detection signal thereof to the ECU 10.

The ECU 10 is electrically connected to the battery 4 and configured to monitor a state of charge SOC of the battery 4. The ECU 10 also corresponds to one example of “charge-state monitoring means” of the disclosure. Further, the ECU 10 is electrically connected to the FC 1 and configured to measure the current and the voltage of the FC 1 and the current and the voltage of the battery 4. The ECU 10 also corresponds to one example of “current-voltage measuring means” of the disclosure.

The ECU 10 is further configured to determine an output value commanded to the motor 2 (a command output value for the motor 2) corresponding to the load device, i.e., a motor command output value. The ECU 10 corresponds to one example of “load output determining means” of the disclosure.

Here, it is necessary to restrict the output of the motor 2 in order to restrict an upper limit of the output of the FC 1 and an upper limit of the output of the battery 4. In the present embodiment, accordingly, the ECU 10 is configured to execute the following “electric power supply control” during operation of the electric cart.

### Electric Power Supply Control

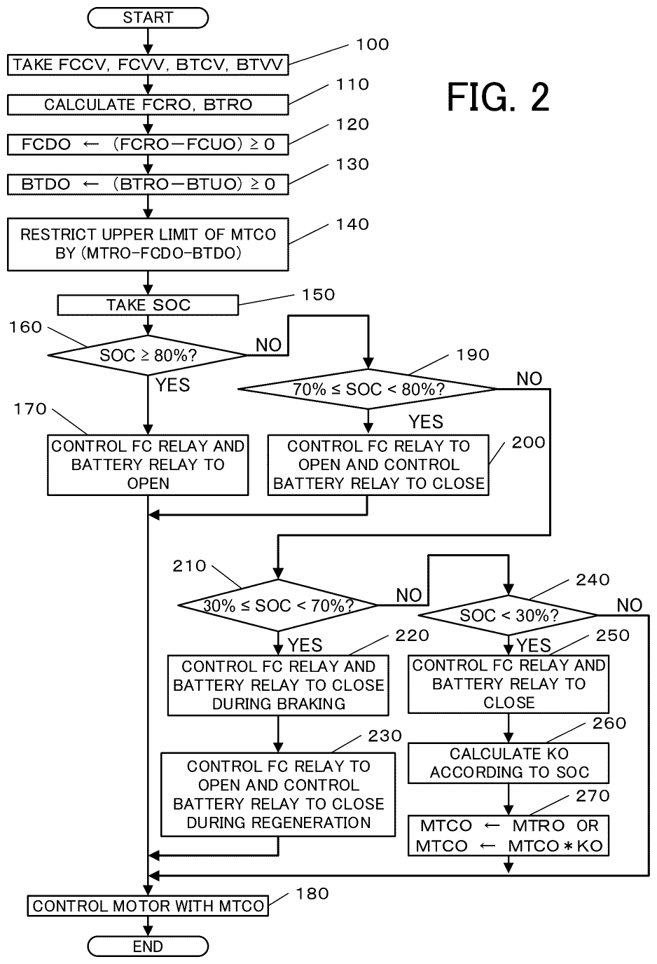

FIG. 2 is a flowchart showing one example of contents of the “electric power supply control” in the present embodiment, stored in the memory of the ECU 10.

When the process enters this routine, in step 100, the ECU 10 takes each of a current value (a FC current value) FCCV and a voltage value (a FC voltage value) FCVV of the FC 1 under measurement, and a current value (a battery current value) BTCV and a voltage value (a battery voltage value) BTVV of the battery 4.

In step 110, the ECU 10 then calculates each of a real output value (an FC real output value) FCRO of the FC 1 and a real output value (a battery real output value) BTRO of the battery 4. Here, the ECU 10 can determine the FC real output value FCRO from the measured FC current value FCCV and FC voltage value FCVV. The ECU 10 can also determine the battery real output value BTRO from the measured battery current value BTCV and battery voltage value BTVV.

In step 120, subsequently, the ECU 10 sets a result value, which is 0 or more, obtained by subtracting an upper-limit output value (an FC upper-limit output value) FCUO of the FC 1 from the FC real output value FCRO, as a reduced output value (a FC reduced output value) FCDO of the FC 1. The FC upper-limit output value FCUO is a set value determined in advance.

In step 130, the ECU 10 sets a result value, which is 0 or more, obtained by subtracting an upper-limit output value (a battery upper-limit output value) BTUO of the battery 4 from the battery real output value BTRO, as a reduced output value (a battery reduced output value) BTDO of the battery 4. The battery upper-limit output value BTUO is a set value determined in advance.

In step 140, the ECU 10 places an upper limit on a command output value (a motor command output value) MTCO for the motor 2 based on a result obtained by subtracting the FC reduced output value FCDO and the battery reduced output value BTDO from a required output value (a motor required output value) MTRO of the motor 2. That is, the motor output is limited based on the battery output and the FC output.

In step 150, the ECU 10 takes a state of charge SOC of the battery 4.

In step 160, the ECU 10 then determines whether or not the state of charge SOC is “80%” or larger. “80%” corresponds to one example of a “first predetermined value” of the disclosure. When this determination result is positive, the ECU 10 advances the process to step 170. When this determination result is negative, the ECU 10 goes to step 190.

In step 170, the ECU 10 controls the FC relay 7 and the battery relay 8 to open.

In step 180, the ECU 10 controls the motor 2 with the motor command output value MTCO, and then terminates subsequent processes.

In contrast, in step 190 following step 160, the ECU 10 determines whether or not the state of charge SOC is “70%” or larger and less than “80%”. “70%” corresponds to one example of a “second predetermined value” of the disclosure. When this determination result is positive, the ECU 10 advances the process to step 200. When this determination result is negative, the ECU 10 goes to step 210.

In step 200, the ECU 10 controls the FC relay 7 to open and controls the battery relay 8 to close, and thereafter proceeds to step 180.

In contrast, in step 210, the ECU 10 determines whether or not the state of charge SOC is “30%” or larger and less than “70%”. “30%” corresponds to one example of a “third predetermined value” (the first predetermined value>the second predetermined value>the third predetermined value) of the disclosure. When this determination result is positive, the ECU 10 advances the process to step 220. When this determination result is negative, the ECU 10 goes to step 240.

In step 220, the ECU 10 controls the FC relay 7 and the battery relay 8 to close during braking of the motor 2.

In step 230, the ECU 10 controls the FC relay 7 to open and controls the battery relay 8 to close during regeneration of the motor 2, and then shifts the process to step 180.

In contrast, in step 240, the ECU 10 determines whether or not the state of charge SOC is less than “30%”. When this determination result is positive, the ECU 10 advances the process to step 250. When this determination result is negative, the ECU 10 goes to step 180.

In step 250, the ECU 10 controls the FC relay 7 and the battery relay 8 to close.

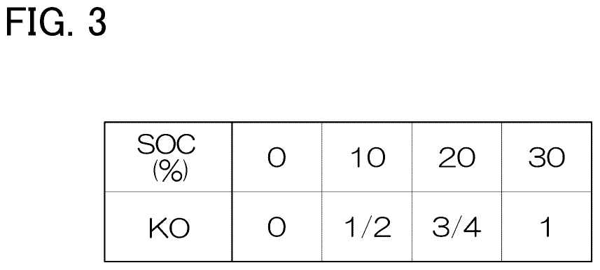

In step 260, the ECU 10 calculates an output correction value KO according to the state of charge SOC. The ECU 10 can determine the output correction value KO according to the state of charge SOC, for example, by referring to an output correction value map shown in FIG. 3.

In step 270, the ECU 10 sets the motor required output value MTRO as the motor command output value MTCO, or, sets a result obtained by multiplying the motor command output value MTCO by the correction value KO as the motor command output value MTCO, and advances the process to step 180.

According to the above-described electric power supply control, when the state of charge SOC of the battery 4 being monitored is smaller than “30%” (the third predetermined value), the ECU 10 is configured to control the FC relay 7 and the battery relay 8 to close in order to restrict the upper limits of output of the FC 1 and output of the battery 4.

Furthermore, according to the above-described electric power supply control, the ECU 10 is configured to: (i) control the FC relay 7 and the battery relay 8 to open when the monitored state of charge SOC is equal to or larger than “80%” (the first predetermined value); (ii) control the FC relay 7 to open and control the battery relay 8 to close when the monitored state of charge SOC is equal to or larger than “70%” (the second predetermined value) and less than “80%”; (iii) control the FC relay 7 and the battery relay 8 to close when the monitored state of charge SOC is equal to or larger than “30%” and less than “70%” and the motor 2 is under braking; and (iv) control the FC relay 7 to open and control the battery relay 8 to close when the state of charge SOC is equal to or larger than “30%” and less than “70%” and the motor 2 is under regeneration.

Moreover, according to the above-described electric power supply control, when the monitored state of charge SOC is smaller than “30%”, the ECU 10 is configured to correct the motor command output value MTCO for the motor 2 according to the state of charge SOC in order to suppress the motor command output value MTCO.

In addition, according to the above-described electric power supply control, the ECU 10 is configured to determine the motor command output value MTCO by subtracting the FC reduced output value FCDO and the battery reduced output value BTDO from the motor required output value MTRO.

### Operations and Effects of Fuel Cell System

According to the fuel cell system configured as described above in the present embodiment, power supply from the FC 1 to the motor 2 is turned on or off by closing or opening the FC relay 7, and power supply from the battery 4 to the motor 2 is turned on or off by closing or opening the battery relay 8. Therefore, by appropriately controlling the opening/closing of the FC relay 7 and the battery relay 8, it is possible to supply the electric power to the motor 2 according to the output conditions of the FC 1 and the battery 4. This configuration can provide a simple and low-cost fuel cell system that can control the electric power to be supplied to the motor 2 so as not to exceed the upper-limit power of the FC 1 and the battery 4 without using a voltage convertor.

According to the configuration in the present embodiment, when the state of charge SOC of the battery 4 under monitoring is smaller than “30%” (the third predetermined value), the ECU 10 controls the FC relay 7 and the battery relay 8 to close, allowing the FC 1 and the battery 4 to output power in an uncontrolled manner. Thus, the output of the FC 1 and the output of the battery 4 can be adjusted to approach the allowable usage range. Therefore, when the state of charge SOC of the battery 4 decreases, the upper limits of the output of the FC 1 and the output of the battery 4 can be restricted.

According to the configuration in the present embodiment, (i) when the monitored state of charge SOC is “80%” (the first predetermined value) or larger, the ECU 10 controls the FC relay 7 and the battery relay 8 to open, so that the output of the FC 1 and the output of the battery 4 are zero. (ii) When the monitored state of charge SOC is “70%” (the second predetermined value) or larger and less than “80%”, the ECU 10 controls the FC relay 7 to open and controls the battery relay 8 to close, so that the output of the FC 1 is zero and the output of the battery 4 is in an uncontrolled state. (iii) When the monitored state of charge SOC is “30%” (the third predetermined value) or larger and less than “70%” and the motor 2 is braking, the ECU 10 controls the FC relay 7 and the battery relay 8 to close, so that the output of the FC 1 and the output of the battery 4 are in an uncontrolled state. (iv) When the monitored state of charge SOC is “30%” or larger and less than “70%” and the motor 2 is under regeneration, the ECU 10 controls the FC relay 7 to open and the battery relay 8 to close, so that the output of the FC 1 is zero and the output of the battery 4 is in an uncontrolled state. Consequently, the output of the FC 1 and the output of the battery 4 are adjusted to approach the allowed usage range. Using the controls (i) to (iv) described above, it is possible to precisely restrict the upper limits of the output of the FC 1 and the output of the battery 4 according to changes in the state of charge SOC of the battery 4.

According to the configuration in the present embodiment, when the monitored state of charge SOC is smaller than “30%”, the ECU 10 corrects the command output value for the motor 2 according to the state of charge SOC to suppress the command output value. Therefore, when the state of charge is smaller than the third predetermined value, power supply from the fuel cell and the battery to the load device (the motor command output value MTCO) is precisely suppressed according to the state of charge. This can precisely limit the upper limit of the output of the FC 1 and the upper limit of the output of the battery 4 when the state of charge SOC of the battery 4 further decreases.

According to the configuration in the present embodiment, the ECU 10 determines the motor command output value MTCO by subtracting the FC reduced output value FCDO and the battery reduced output value BTDO from the motor required output value MTRO. Thus, the motor command output value MTCO is determined to match the output capacity condition of the FC 1 and the output capacity condition of the battery 4 at that time. This can prevent excessive output load from being placed on the FC 1 and the battery 4.

The disclosure is not limited to each of the aforementioned embodiments, and may be implemented with appropriate changes to some of the configurations without departing from the essential characteristics of the disclosure.

In the above-described embodiment, for example, the electrically-operated motor 2 is adopted as the load device. However, any other electric motors may be adopted.

### INDUSTRIAL APPLICABILITY

The disclosure can be utilized to fuel cell systems mounted in electric vehicles.

### REFERENCE SIGNS LIST

1 FC (Fuel Cell)
2 Motor (Load device)
3 First power line
4 Battery
5 Second power line
7 FC relay (First relay)
8 Battery relay (Second relay)
10 ECU (Relay control means, Charging-rate monitoring means, Load output determining means)

1. A fuel cell system comprising:
a fuel cell;
a load device;
a first power line connecting the fuel cell and the load device;
a battery; and
a second power line connecting the battery and the first power line,
wherein the fuel cell system further comprises:
a first relay provided on the first power line to open and close the first power line; and
a second relay provided on the second power line to open and close the second power line.

2. The fuel cell system according to claim 1, comprising:
relay control means for controlling the first relay and the second relay to open and close to restrict an upper limit of output of the fuel cell and an upper limit of output of the battery; and
charge-state monitoring means for monitoring a state of charge of the battery,
wherein the relay control means controls the first relay and the second relay to close when the state of charge of the battery being monitored by the charge-state monitoring means is smaller than a third predetermined value.

3. The fuel cell system according to claim 2, wherein
the relay control means is configured to:
(i) control the first relay and the second relay to open when the monitored state of charge is a first predetermined value or larger;
(ii) control the first relay to open and the second relay to close when the monitored state of charge is a second predetermined value or larger and less than the first predetermined value;
(iii) control the first relay and the second relay to close when the monitored state of charge is the third predetermined value or larger and less than the second predetermined value and the load device is under braking; and
(iv) control the first relay to open and the second relay to close when the monitored state of charge is the third predetermined value or larger and less than the second predetermined value and the load device is under regeneration, and
have a relationship: the first predetermined value>the second predetermined value>the third predetermined value.

4. The fuel cell system according to claim 2, wherein
when the monitored state of charge is smaller than the third predetermined value, the relay control means corrects a command output value for the load device according to the state of charge to suppress the command output value.

5. The fuel cell system according to claim 1, comprising load output determining means for determining a command output value for the load device,
wherein the load output determining means determines the command output value by subtracting a reduced output value of the fuel cell and a reduced output value of the battery from a required output value of the load device.

6. The fuel cell system according to claim 3, wherein
when the monitored state of charge is smaller than the third predetermined value, the relay control means corrects a command output value for the load device according to the state of charge to suppress the command output value.
